(19) United States
(12) Patent Application Publication
(10) Pub. No.: US 2015/0065212 A1
(43) Pub. Date: Mar. 5, 2015

(54) THRESHING DEVICE

(71) Applicant: Bertil Kvist, Hagersten (SE)

(72) Inventor: Bertil Kvist, Hagersten (SE)

(73) Assignee: Gunnar Eklöf, Täby (SE)

(21) Appl. No.: 14/240,891

(22) PCT Filed: Aug. 27, 2012
(86) PCT No.: PCT/SE2012/050904

§ 371 Date: Oct. 10, 2014

(30) Foreign Application Priority Data
Aug. 26, 2011 (SE) 1150771-2

(51) Int. Cl. A01F 7/06; A01F 7/70

(52) U.S. Cl. CPC A01F 7/06; A01F 7/70; A01F 7/067
USPC 460/61

(57) ABSTRACT

A threshing device includes a threshing part with a rotatable unit which includes at least a flail and a concave which surrounds the rotatable unit. The concave is rotatably arranged in an opposite direction in relation to the rotatable unit. The threshing device includes a cleaning part with a rotatably mounted sieve, which surrounds the concave. A fan is arranged to provide an air stream towards the sieve for preventing the cleaned parts of the threshed material to pass through the sieve. The air stream is also arranged to transport out the cleaned parts which are collected in a space between the sieve and the concave.

### FIELD OF THE INVENTION

The present invention relates to a threshing device for threshing of a material, wherein the threshing device comprises a first rotatable unit which comprises at least a flail, a concave which is rotatably arranged in the threshing device and at least partly surrounds the rotatable unit; a rotatably mounted sieve, which surrounds the concave and first transport means which is arranged to feed and transport said material in a substantially axial direction in a space between the first rotatable unit and the concave such that the material is subjected to a threshing in a threshing gap formed between the flail of the first rotatable unit and the inner surfaces of the concave.

### BACKGROUND OF THE INVENTION

A conventional combined harvester for straw seed has, at a front portion, a shear table where the straws of the crop are cut off whereupon they are fed into a subsequent threshing apparatus. The threshing apparatus consists of a threshing cylinder with smooth or grooved flails partly surrounded of a usually perforated concave provided with transverse concave rulers. When the threshing cylinder is rotated, the grains and the husks of the material are beaten loose from straws. The grains and the husks are led to a cleaning unit. The straws are thrown out on a straw shaker where remaining grains and husks are separated whereupon they are led to the cleaning unit. In the cleaning unit, the husks and chaff are lifted by an air stream from a fan and moved out while the heavier grains are led through a sieve to a collection tank.

Conventional combined harvesters comprise a plurality of separate units in the form of a threshing unit, a straw shaker and a cleaning unit, which units are located at distances from each other. Thus, a conventional combined harvester obtains a large dimension and a large weight. The respective including parts also itself comprise a plurality of movable parts such that the total number of movable parts of the combined harvester which require a service work are quiet large.

### SUMMARY

The object of the present invention is to provide a threshing device which is compact, has few movable parts and has a low weight at the same time as it provides an effective threshing of a material.

In the present threshing device, the principle is applied to transport the material in a mainly axial direction on the inside of the concave. When a flail passes the material a threshing of the material is performed in the threshing gap formed between the flail and the concave. The concave is with advantage cylinder-shaped i.e. it extends 360° around the internally rotated flails. Thus, it provides a relatively large surface for the threshing work. Such a cylinder-shaped concave may thus be given a relatively short length which results in that the threshing device may be given a compact design. Since the concave is rotatable, the threshed material, which is in contact with the concave, is subjected to a centrifugal force which facilitates the passage of the threshed material through the peripheral openings of the concave which are located between the rulers of the concave. The threshed out grains which are relatively small but heavy are thereby led substantially direct out by help of the centrifugal force via said peripheral openings. Thus, the risk for threshing damage on the grains decreases. The particles in the threshed material which are relatively large and light such as straw and the like do not pass as easily through the peripheral openings of the concaves. It is therefore possible already in the threshing part to obtain a good separation of cleaned material with the present threshing device.

According to a preferred embodiment of the present invention, the concave and the first rotatable unit are operable in opposite directions in relation to each other. The first rotatable unit which comprises at least a flail and the concave may when they are driven in opposite direction be given relatively moderate speeds since it is the relative speed between the flail and the concave which is relevant for the threshing work. Advantageously, the concave and the first rotatable unit are individually operable. Thus, the concave and the first rotatable unit may be driven by separate drive devices and be given a variable speed in relation to each other such that an optimal threshing of grains may be obtained for different kinds of cereal.

According to a preferred embodiment of the present invention, said first transport means comprises a helically shaped element which is attached on the inside of the concave. When the concave is rotated, the material provides a transport in a mainly axial direction by the helically shaped element along a helically shaped path in direction towards an outlet opening for the cleaned material. The helically shaped element has a height which is less than the threshing gap. The threshing gap may be about 1 cm.

According to the present invention, the threshing device includes a rotatably mounted sieve, which surrounds the concave. Such a sieve which with advantage is cylinder shaped has peripheral openings of a size such that less particles such as grains and husks of the threshed material can pass through the sieve. Larger particles of the threshed material which not can pass through the sieve are collected in the space between the concave and the sieve. In one embodiment, the sieve includes adjustable means which allows the size of the peripheral openings to be varied for enabling an effective separation of grains from different kinds of cereal. Advantageously, the concave is connected to the sieve such they are comprised in a second rotatable unit. Since both the concave and the sieve are suited to perform a rotary motion, it is suitable to connect these components to each other in such a second rotatable unit. The concave and the sieve may thus be driven by a common drive device. Such a connection reduces also the number of individual moveable components of the threshing device.

According to the present invention, the threshing device includes a fan which is arranged to provide an air stream which leads air radially inwardly towards the peripheral openings of the sieve. The force by which the different particles of the threshed material are pressed radially outwardly by the centrifugal force in the rotatable sieve is related to the weight of the respective particles. Thus, the grains of the material which are relatively small and heavy may without problem be pressed radially outwardly by the centrifugal force through the peripheral openings of the sieve against the action by said air stream. However, the husks and other lightweight cleaning material are prevented by the air stream to pass through the peripheral openings of the sieve. Consequently, it is possible by means of a fan which provides a well suited air stream, to provide an effective cleaning of grains from husks and chaff. Said fan may initially provide a substantially axial air stream in the space outside the sieve, wherein the threshing device comprises guide elements which are arranged to direct the axial air stream radially inwardly towards the cylinder-shaped sieve. The guide elements may have a substantially conical shape and they may be attached on the sieve. With a plurality of such conical guide elements with a successively increasing size which are arranged after each other, it is possible to divide and deflect an axial air stream to a plurality of air streams which at least partly is directed radially inwardly towards the sieve along its entire extension. Threshing, separation and cleaning of a material are here provided in different steps in spaces located radially outwardly of each other. The transport distances of the material between the different spaces become thus extremely short. The threshing device may thus be made very compact and be given a low weight.

Preferably, the threshing device comprises second transport means which is arranged to transport out cleaned parts of the threshed material, which is collected in the space between the concave and the sieve. Advantageously, the already existing air stream which passes through the peripheral openings of the sieves may here be used. Since this air stream reaches the space between the sieve and the concave, it is led in a substantially axial direction in the space between the sieve and the concave towards an outlet opening. Thus, this air stream carries the relatively light weight cleaned material towards the outlet opening. Preferably, the threshing device comprises a housing which surrounds the sieve, which house is arranged to collect the grains from the threshed material and to lead out the grains from the housing via an outlet opening. Such a housing also contains and protects the first rotatable unit and the second rotatable unit of the threshing device. The threshing device also comprises means which makes it possible to give the housing a desired inclination and means which makes it possible to adjust the threshing gap to a desired size.

The threshing device comprises with advantage cutters and counterholds element which shred the threshing material before it is fed into the space between the first rotatable unit and the concave. Thus, the threshing work in said space is facilitated. The cutters may be arranged on the first rotatable unit and the counterholds element on the second rotatable unit such they rotate in opposite directions. The counterholds element may alternatively be arranged on a stationary wall or the like. In one embodiment, the threshing device includes at least an additional sieve which is arranged radially outwardly of the ordinary sieve. The additional sieve has with advantage a cylindrical shape with holes of a size such that only grains can pass through the sieve. The additional sieve is attached on the second rotatable unit.

### BRIEF DESCRIPTION OF THE DRAWINGS

In the following a preferred embodiment of the invention is described as an example with reference to the attached drawings, on which:

FIG. 1 is a cross section view through a threshing device according to a first embodiment of the invention,

FIG. 2 shows the threshing device in FIG. 1 seen from a first gable side,

FIG. 3 shows a cross section view through the plane A-A in FIG. 1,

FIG. 4 shows the threshing device in FIG. 1 seen from a second gable side,

FIG. 5 is a cross section view through a threshing device according to a second embodiment of the invention and

FIG. 6 is a cross section view through the plane B in FIG. 5.

### DETAILED DESCRIPTION OF THE INVENTION

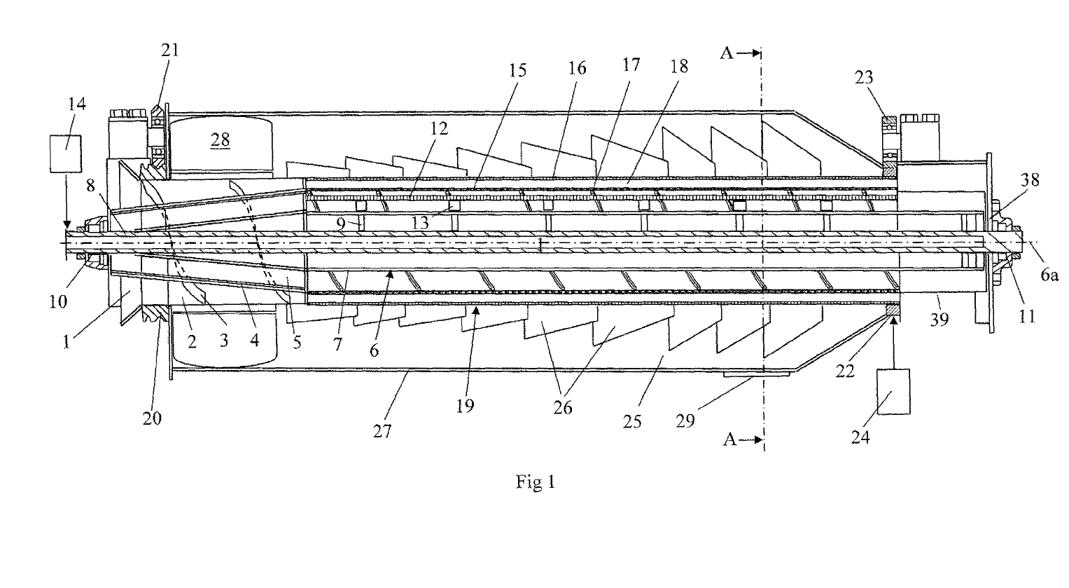

FIG. 1 shows a threshing device according to the present invention. Material such as straw seed, is fed into the threshing device via an inlet opening 1 which is located at a first gable side of the threshing device. The threshing device comprises in connection to the inlet opening 1 an outer space 2 where a feeding screw 3 is arranged. A number of inclined elongated elements 4 form a conical portion between the outer space 2 and an inner space 5. The threshing device includes a first rotatable unit 6 which is rotatably arranged around a centre axis 6a. The first rotatable unit 6 comprises a shaft 8 which is connected to a radially outwardly cylindrical portion 7 by means of a plurality of first connection elements 9. The shaft 8 is rotatably mounted in a first bearing 10, which is located on the first gable side of the threshing device, and in a second bearing 11, which is located on a second gable side of the threshing device. The cylindrical portion 7 is, via a plurality of second connection elements 13, connected to three elongated flails 12 of which one is shown in FIG. 1. The flails 12 may have smooth or grooved external surfaces. Consequently, the first rotatable unit 6 consists of the shaft 8, the first connection elements 9, the cylindrical portion 7, the second connection elements 13 and the flails 12. The shaft 8 is connected to a schematically shown drive device 14. The driving device 14 may be of a substantially arbitrary kind. However, it ought to have a construction such that it can provide a drive of the first rotatable unit 6 with a variable speed.

The first rotatable unit 6 is surrounded by a cylinder-shaped concave 15. The concave 15 is located at a radial distance from the flails 12 such that a threshing gap is formed between their adjacent surfaces. The concave 15 comprises concave rulers with intermittent openings which the threshed material can pass through. The cylinder-shaped concave 15 is surrounded by a cylinder-shaped sieve 16. The cylinder-shaped sieve 16 includes peripheral openings which have a smaller size than the peripheral openings of the concaves 15 such that only lesser particles such as grains and husks can pass through the openings but not larger particles of the threshed material such as straw. The cylinder-shaped concave 15 includes, at an internal surface, a weld attached helically shaped element 17.

The cylinder-shaped concave 15 and the cylinder-shaped sieve 16 are connected to each other by means of suitable connection elements. The cylinder-shaped concave 15 and the cylinder-shaped sieve 16 are thus comprised in a second rotatable unit 19 of the threshing device. The second rotatable unit 19 has, at the first gable side, a first annular element 20 which is in contact with a number of first wheel members 21. The second rotatable unit 19 comprises, at the second gable side, a second annular element 22 which is in contact with a number of second wheel members 23. The second rotatable unit 19 is thus also mainly rotatably arranged around the center shaft 6a by means of said annular elements 20, 22 and wheel members 21, 23. The second rotatable unit 19 is connected to a schematically shown drive device 24. The drive device 24 may be of a suitable type, such as one that has a construction such that it can provide an individual drive of the second rotatable unit 19 with a variable speed. A plurality of conically-shaped guide elements 26 are attached on a radially outwardly surface of the cylinder-shaped sieve 16. The conical guide elements 26 are arranged after each other with a successively increasing size in direction towards the second gable side. The first rotatable unit 6 and the second rotatable unit 19 are arranged in a house 27 which forms a surrounding casing and protection for the rotatable units 6, 19. A fan 28 is arranged inside the house 1 in connection to the first gable side. The house 27 also has the task to receive the grains from the material and it comprises an outlet opening 29 where the grains are led out.

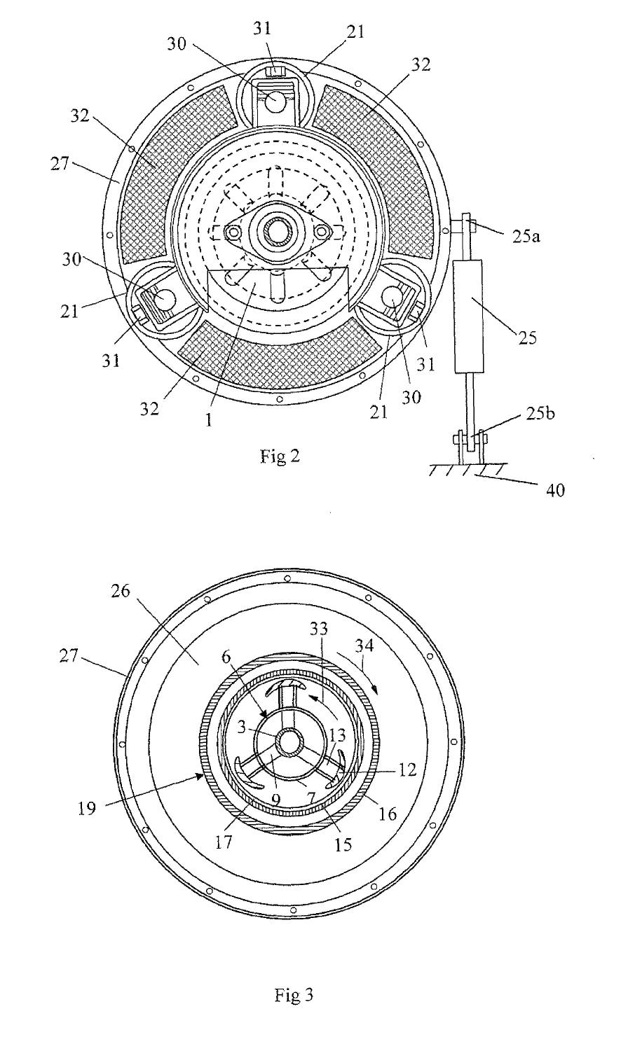

FIG. 2 shows the first gable side of the threshing device. The inlet opening 1 is, inter alia, here seen where the material is fed in. A number of first wheel members 21 are arranged with constant intervals for providing a rotary motion of the second rotatable unit 19. The wheel members 21 have shafts 30 which are attached by means of adjustable screws 31. By adjustment of the screws 31, the position of the wheel shafts 30 can be adjusted and thus the rotary axis of the second rotatable unit 19 and the flails such that it does not completely coincides with the rotary axis 6a of the first rotatable unit. The threshing gap formed between the concave 15 of the second rotatable unit 19 and the flails 12 of the first rotatable unit can thus be adjusted to a desired value at the first gable side. The threshing device is settable in different inclination angles by means of an actuator which here is exemplified in the form of a hydraulic cylinder 25. The hydraulic cylinder 25 is, at a first end 25a, attached to a part of the house 27 in vicinity of the first gable portion and, at a second end 25b, attached to a stationary portion 40 which supports the threshing device. Three inlet openings 32 for air are arranged between the wheel members 21, via which the fan 28 is arranged to such in air in the housing 27.

FIG. 3 show a cross section view along the plane A-A in FIG. 1. It is here seen that the shaft 8 is connected to the cylindrical portion 7 at a connection area by means of three first connection elements 9. The cylindrical portion 7 is connected to three flails 12 by means of three second connection elements 13 at the same connection area. The first rotatable unit 6 which thus comprises the shaft 8, the first connection elements 9, the cylindrical portion 7, the second connection elements 13 and the flails 12 is driven in a first rotation direction 33. The outwardly located concave 15 is located at a radial distance from the flails 12 such that between these components is formed a threshing gap of a suitable size. The helically-shaped element 17, which is arranged in the threshing gap, has thus a smaller radial extension than the threshing gap. The second rotatable unit 19 which comprises the concave 15 and the sieve 16 is with advantage driven in a second rotation direction 34 which is opposite to the first rotation direction 35. The conical guide elements 26 extend around the cylinder-shaped sieve 16.

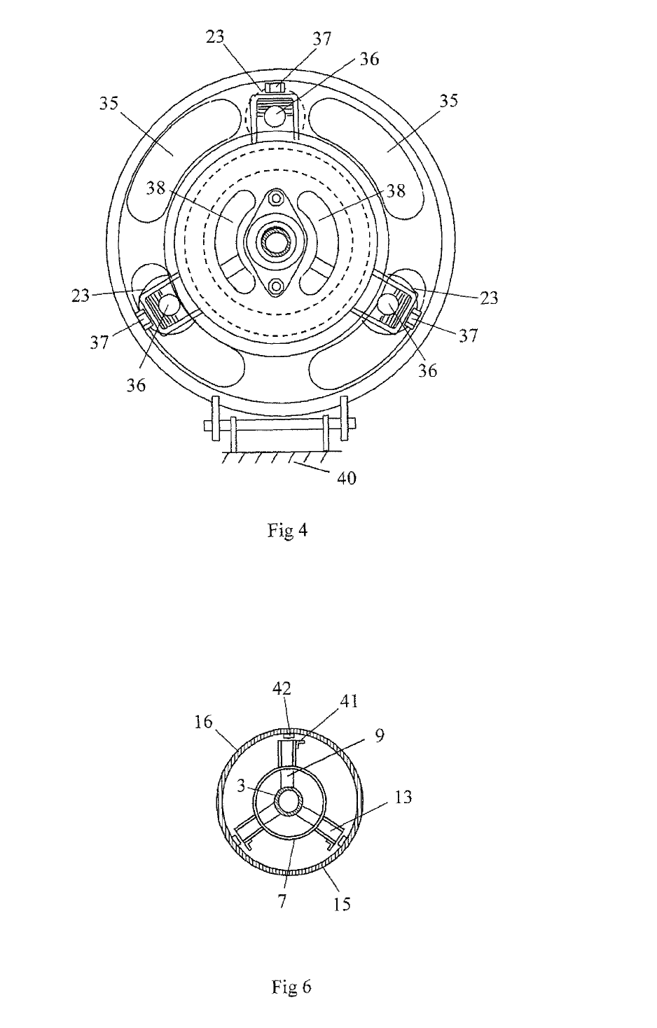

FIG. 4 shows the second gable side of the threshing device. It is here seen, inter alia, four outlet openings 35 for leading out a part of the air which is sucked into the house 27 by means of the fan 28. A number of second wheel members 23 are arranged with constant intervals for providing a bearing of the second rotatable unit 19 at the second gable side. The wheel members 23 have shafts 36 which are attached by means of adjustable screws 37 in relation to the house 27. By adjustment of the screws 37, the position of the wheel shafts 36 can be adjusted and thus the rotary axis 19 of the second rotatable unit in connection to the second gable part. The threshing gap formed between the concave 15 of the second rotatable unit 19 and the flails 12 of the first rotatable unit may thus also be adjusted in connection to the second gable part. The threshing device includes, at the second gable side, two outlet openings 38 for cleaned material which are transported out from the space 18 between the concave 15 and the sieve 16. The threshing device is pivotally mounted on the stationary portion 40, at the second gable side, such that the threshing device can be turned in its length direction and be given a suitable inclination by means of the hydraulic cylinder 25. Three inlet openings 32 for air are arranged between the wheel members 21, via which the fan 28 is arranged to suck in air in the house 27.

During operation of the threshing device, the material is fed in through the inlet opening 1 to the space 2. The feeding screw 3 in the outer space 2 is attached on the second rotatable unit 19. During rotation of the second rotatable unit 19, the material is fed by means of the feeding screw 3 in an axial direction and radially inwardly such that the material is led in between de elongated elements 4 to the inner space 5. The material is led from the inner space 5 further in an axial direction into a space between the cylindrical portion 7 and the surrounded cylinder-shaped concave 15 of the helically-shaped element 17. The cylindrical portion 7 and the flails 12, which constitute parts of the first rotatable unit 6, rotates here in the first rotation direction 33 while the concave 15, which constituters a part of the second rotatable unit 19, rotates in the opposite rotary direction 34. The material is transported in this space of the helically-shaped element 17 in form of a loose and for grains and husks permeable layer in a substantially axial direction along the internal surface of the concave 15. In the threshing gap between the flails 12 and the concave 15, grains, husks and straw are beating loose from each other. Grains, husks and chaff which have a sufficiently small size pass hereby through the peripheral openings of the concaves 15. Larger particles such as straw are transported by the helically-shaped element 17 successively further in an axial direction until this cleaned material is led out through the outlet openings 38. With the present threshing device, a relatively large separation of cleaned material is already provided in the threshing part.

The particles of the threshed material, which have passed through the peripheral openings of the concave 15 reaches the space 18 which is located between the concave 15 and the cylinder-shaped sieve 16. The rotary motion of the second rotatable unit 19 results in that material is pressed radially outwardly in the space 18 by the centrifugal force. The cylinder-shaped sieve 16 has peripheral openings of a size which only is possible to pass through for smaller particles such as grains and husks of the threshed material. The fan 28 provides during operation a substantially axial air stream in the space between the cylinder-shaped sieve 16 and the housing 27 from den first gable side towards the second gable side. The axial air stream hits the guide elements 26 arranged after each other on different height levels which have surfaces deflect the axial air stream radially inwardly towards the cylinder-shaped sieve 16. Thus, a plurality of substantially uniform air streams are provided radially inwardly towards the openings of the cylinder-shaped sieves 16 substantially along the entire length of the sieve 16. The main part of the air in these inwardly directed air streams passes through the peripheral openings of the cylinder-shaped sieve 16. The force by which the different particles of the threshed material are pressed radially outwardly towards the cylinder-shaped sieve 16 by the centrifugal force is related to the weight of the respective particles. The grains of the threshed material which are relatively small but heavy are pressed outwardly by the centrifugal force and led, without problem, through peripheral openings of the cylinder-shaped sieve 16 against the action of said radially inwardly directed air streams.

The husks and chaff of the threshed crop material which constitute lightweight particles are not pressed radially outwardly by the centrifugal force with a sufficiently large force but they are prevented to pass through the peripheral openings of the cylinder-shaped sieve 16 by the radially inwardly directed air streams. Possible husks and chaff which unlikely passes through the peripheral openings of the cylinder-shaped sieve 16 are blown almost immediately back to the space 18 by the inwardly directed air stream. Lightweight particles such as husks and chaff are thus transported together with the other cleaned material which is too large for passing through the peripheral openings of the cylinder-shaped sieve 16 in an axial direction in the space 18 by means of the air stream towards the outlet opening 39. The fan 28 ought to be adjustable such that the air flow if necessary can be varied to a level such that an optimal cleaning of husks and chaff from the material is obtained, for example, for different types of cereal. With the above mentioned cleaning method, only the relatively heavy grains will be collected inside the housing 27. The grains which are thrown substantially radially outwardly when they pass through the sieve 16 are thereafter collected on a lower inner surface of the house 27. The housing 27 can be inclined with an angle by means of the hydraulic cylinder 25 such that outflow of grains from the house 27 is facilitated. The transport of grains towards the outlet opening 29 also is facilitated by the part of the axial air stream from the fan 28 which not is directed radially inwardly. This axial air stream blows, at the lower portion of the house, the grains in direction towards the outlet opening 29 which here is located in connection to the second gable side.

A conventional combined harvester for harvesting straw seed has at a front portion a shear table with a cutting apparatus where the straw of the cereal is cut off and a feeding screw and feeding elevator for feeding in the material in a subsequent threshing apparatus. A conventional combined harvester also comprises a straw shaker and a cleaning unit. The above mentioned threshing device may be arranged after a conventional shear table in a combined harvester and replace the straw shaker and the cleaning unit of the combined harvester. A combined harvester with such a threshing device provides thus a very compact construction and a low weight. It also has few movable parts which provide an effective threshing, separation and cleaning of material.

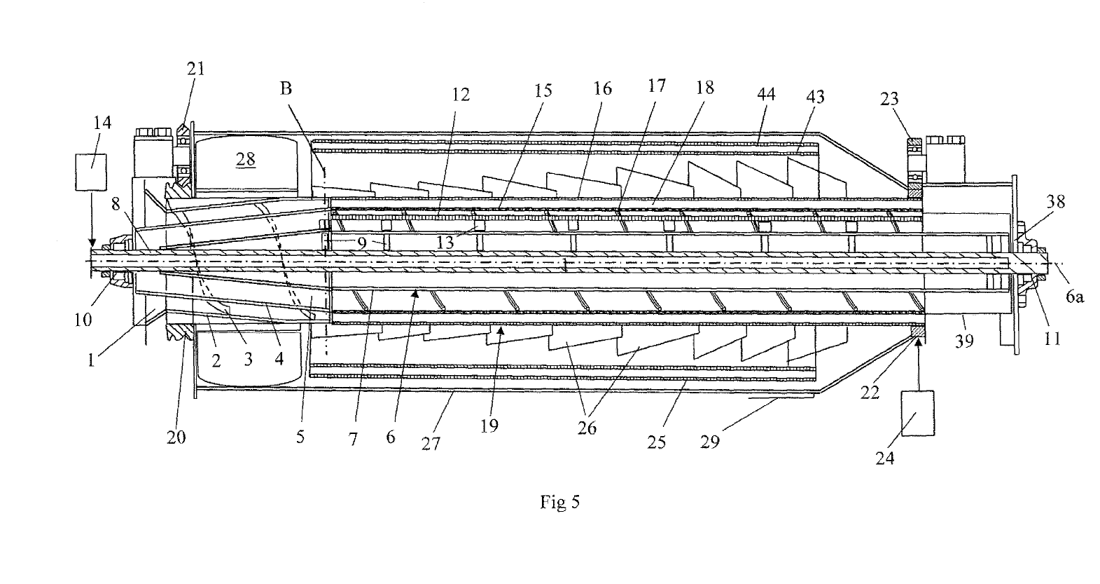

FIG. 5 shows a modified embodiment of the threshing device. In this case, the threshing device comprises an outer space 2 which is defined by an outer conical element 2a and an inner conical element 4. The outer conical element 2a is provided with a feeding screw 3 for feeding of material. The inner conical element 4 comprises a number of inclined elongated elements 4 which are arranged between the outer space 2 and an inner space 5. At the end of the inner space 5, see FIG. 6, L-shaped cutters 41 are arranged. A suitable numbers of counterholds element 42 are arranged radially outside the cutters 41. The cutters 41 and the counterholds element 42 have the task to shred the material in the inner space 5 before it is led further in an axial direction into the space between the cylindrical portion 7 and the surrounded cylinder-shaped concave 15 by the helically-shaped element 17. The threshing device has also been provided with two outer sieves 43, 44. The outer sieves 43, 44 are provided with a large number of holes which have a size corresponding to the size of the grains. The outermost arranged sieve 44 may be provided with slightly smaller holes the second outer sieve 43. This ensures that only grains are led to the outlet opening 29.

The present invention is not in any way restricted to the above on the drawing described embodiments but may vary within the scope of the claims.

What is claimed is:

1-10. (canceled)

11. A threshing device for threshing of a material, the threshing device comprising:
a first rotatable unit which comprises at least a flail;
a concave which is rotatably arranged in the threshing device and at least partly surrounds the rotatable unit;
a rotatably mounted sieve, which surrounds the concave; and
first transport means which is arranged to feed and transport grains in a substantially axial direction in a space between the first rotatable unit and the concave such that the grains are subjected to a threshing in a threshing gap formed between the flail of the first rotatable unit and the internal surfaces of the concave; and
the threshing device comprising a fan which is arranged to provide an air stream which leads air in an at least partly radial direction inwardly towards the sieve.

12. The threshing device according to claim 11, wherein the rotatable concave and the first rotatable unit are operable in opposite directions in relation to each other.

13. The threshing device according to claim 11, wherein the concave and the first rotatable unit are individually operable.

14. The threshing device according to claim 11, wherein said first transport means comprises a helically shaped element which is attached on the inside of the concave.

15. The threshing device according to claim 11, wherein the concave is connected to the sieve such that they are comprised in a second rotatable unit.

16. The threshing device according to claim 11, wherein said fan initially provides a substantially axial air stream outwardly of the sieve, wherein the threshing device comprises guide elements which is arranged to deflect the axial air stream radially inwardly towards the sieve.

17. The threshing device according to claim 11, wherein the threshing device comprises second transport means which is arranged to transport out cleaned parts of the threshed material which is collected in a space between the sieve and the concave.

18. The threshing device according to claim 11, wherein the threshing device comprises a housing which surrounds the sieve, the housing being arranged to collect the grains from the threshed material and to lead the grains out of the housing via an outlet opening.

19. The threshing device according to claim 11, wherein the threshing device comprises cutters and counterholds element which shred the material before it is fed into the space between the first rotatable unit and the concave.

20. The threshing device according to claim 11, wherein the threshing device comprises at least an additional sieve which is arranged radially outwardly of said sieve.
